(19) United States
(12) Patent Application Publication
(10) Pub. No.: US 2022/0234616 A1
(43) Pub. Date: Jul. 28, 2022

(54) VEHICLE CONTROL APPARATUS, VEHICLE CONTROL METHOD, AND VEHICLE CONTROL PROGRAM PRODUCT

(71) Applicant: DENSO CORPORATION, Kariya-city (JP)

(72) Inventors: Megumi ANAMI, Kariya-city (JP); Haengtae CHUNG, Kariya-city (JP)

(21) Appl. No.: 17/575,740

(22) Filed: Jan. 14, 2022

(30) Foreign Application Priority Data
Jan. 22, 2021 (JP) 2021-009031

(51) Int. Cl. B60W 60/00; B60W 50/14

(52) U.S. Cl. CPC B60W 60/0013; B60W 50/14; B60W 2050/146; B60W 2540/215; B60W 2554/404; B60W 2554/802; B60W 2520/04; B60W 2520/105; B60W 2520/125; B60W 2554/801

(57) ABSTRACT

A vehicle control apparatus, which controls an execution of an autonomous driving of a vehicle, is configured to: acquire a driving characteristic information item indicating a numerical value or a degree of a driving characteristic used in an autonomous driving of the vehicle; and set the driving characteristic to be used in the autonomous driving of the vehicle with the acquired driving characteristic information item. The driving characteristic to be used in the autonomous driving is set using the acquired driving characteristic information item to be different from a driving characteristic of a manual driving operation performed by a user of the vehicle.

### CROSS REFERENCE TO RELATED APPLICATION

The present application claims the benefit of priority from Japanese Patent Application No. 2021-009031 filed on Jan. 22, 2021. The entire disclosure of the above application is incorporated herein by reference.

### TECHNICAL FIELD

The present disclosure relates to a vehicle control apparatus, a vehicle control method, and a vehicle control program product.

### BACKGROUND

There has been known a vehicle control apparatus that changes a vehicle start characteristic or a driving characteristic from a basic characteristic based on a driving characteristic of a vehicle occupant.

### SUMMARY

A vehicle control apparatus, which controls an execution of an autonomous driving of a vehicle, is configured to: acquire a driving characteristic information item indicating a numerical value or a degree of a driving characteristic used in an autonomous driving of the vehicle; and set the driving characteristic to be used in the autonomous driving of the vehicle with the acquired driving characteristic information item. The driving characteristic to be used in the autonomous driving is set using the acquired driving characteristic information item to be different from a driving characteristic of a manual driving operation performed by a user of the vehicle.

### BRIEF DESCRIPTION OF DRAWINGS

Objects, features and advantages of the present disclosure will become apparent from the following detailed description made with reference to the accompanying drawings. In the drawings:

FIG. 1 is an explanatory diagram showing a vehicle control system;

FIG. 2 is a block diagram showing a configuration related to vehicle control including autonomous driving according to the present disclosure;

FIG. 3 is a flowchart showing a vehicle control including autonomous driving according to the present disclosure;

FIG. 4 is a flowchart showing a process executed in S110 of FIG. 3;

FIG. 5 is a flowchart showing a processes executed in S130 of FIG. 3;

FIG. 6 is an explanatory diagram showing acquisition of area characteristic information;

FIG. 7 is a block diagram showing a configuration related to vehicle control including autonomous driving according to a second embodiment of the present disclosure; and

FIG. 8 is a flowchart showing a vehicle control including autonomous driving according to the second embodiment.

### DETAILED DESCRIPTION

JP 2019-172089 A (corresponding to US 2019/0300015 A1) discloses a vehicle control apparatus that changes a vehicle start characteristic or a driving characteristic from a basic characteristic based on a driving characteristic of a vehicle occupant. The disclosed vehicle control apparatus reduces a sense of discomfort when the occupant changes the vehicle. The disclosure of JP 2019-172089 A is incorporated herein by reference.

In the above vehicle control apparatus, a reaction force generated by a reaction force generator in an accelerator pedal or the like is controlled to reduce the discomfort when the driver may feel during operation of the vehicle. In addition, the characteristic information of the person who is regarded as a driver is reflected in the autonomous driving of the vehicle. However, the driver does not always require the same characteristic in the autonomous driving as the characteristic of manual driving.

In a case where the driver requires a different driving characteristic during autonomous driving from that of manual driving, when the vehicle is controlled with the driving characteristics of the autonomous driving same as that of manual driving, the vehicle may fail to improve user experience related to autonomous driving. For this reason and other reasons that are not described, further improvement is required to be made in the vehicle control apparatus that controls autonomous driving of the vehicle.

According to an aspect of the present disclosure, a vehicle control apparatus, which controls an execution of an autonomous driving of a vehicle, includes: a characteristic acquisition unit that acquires a driving characteristic information item indicating a numerical value or a degree of a driving characteristic used in an autonomous driving of the vehicle; and a characteristic setting unit that sets the driving characteristic to be used in the autonomous driving of the vehicle with the driving characteristic information item acquired by the characteristic acquisition unit. The characteristic setting unit sets the driving characteristic to be used in the autonomous driving with the driving characteristic information item that is acquired to be different from a driving characteristic of a manual driving operation performed by a user of the vehicle.

According to another aspect of the present disclosure, a vehicle control method, which controls an execution of an autonomous driving of a vehicle, includes: acquiring a driving characteristic information item indicating a numerical value or a degree of a driving characteristic used in an autonomous driving of the vehicle; and setting the driving characteristic to be used in the autonomous driving of the vehicle with the acquired driving characteristic information item. The driving characteristic to be used in the autonomous driving is set with the acquired driving characteristic information item to be different from a driving characteristic of a manual driving performed by a user of the vehicle.

According to another aspect of the present disclosure, a vehicle control program product, which controls an execution of an autonomous driving of a vehicle, is stored in a computer-readable non-transitory tangible storage medium as instructions to be executed by a computer. The instructions include: acquiring a driving characteristic information item indicating a numerical value or a degree of a driving characteristic used in an autonomous driving of the vehicle; and setting the driving characteristic to be used in the autonomous driving of the vehicle with the acquired driving characteristic information item. The driving characteristic to be used in the autonomous driving is set with the acquired driving characteristic information item to be different from a driving characteristic of a manual driving performed by a user of the vehicle.

According to the above vehicle control apparatus, vehicle control method, and vehicle control program product, the driving characteristic of autonomous driving can be set using driving characteristic information item indicating a different driving characteristic from a driving characteristic of a manual driving performed by a user of the vehicle. Thus, it is possible to set a driving characteristic to be used in the autonomous driving of the vehicle according to a preference of the user such that the driving characteristic different from that of manual driving performed by the user can be set as the driving characteristic of autonomous driving. Further, it is possible to provide a vehicle control apparatus, a vehicle control method, and a vehicle control program product each of which is capable of providing highly comfortable autonomous driving for a driver who feels more comfortable when the autonomous driving is executed based on a different driving characteristic from the driving characteristic of the user's own manual driving.

The disclosed aspects in this specification adopt different technical solutions from each other in order to achieve their respective objectives. The objects, features, and advantages disclosed in this specification will become apparent by referring to following detailed descriptions and accompanying drawings.

Multiple embodiments will be described with reference to the drawings. In some embodiments, functionally and/or structurally corresponding and/or associated parts may be given the same reference numerals, or reference numerals with different digit placed on equal to or higher than a hundred place. For corresponding parts and/or associated parts, reference can be made to the description of other embodiments.

### First Embodiment

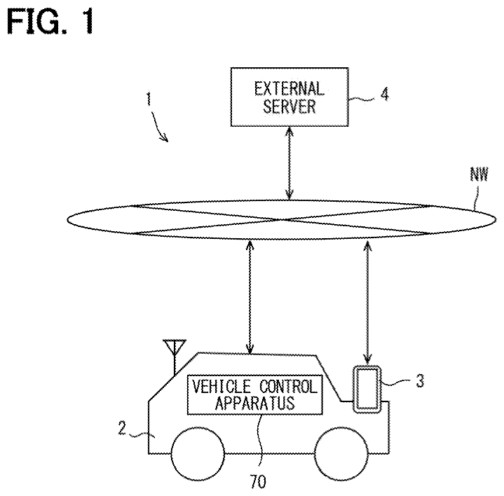

In FIG. 1, a vehicle control system 1 is a system for performing an autonomous driving of a vehicle 2 by using a vehicle control apparatus 70 mounted on the vehicle 2. Details of the vehicle control apparatus 70 will be described later. The vehicle 2 is capable of executing a constant or temporary autonomous driving in an autonomous driving control mode.

As the automation level indicating a degree of autonomous driving, multiple levels may be defined as the definition made by American Society of Automotive Engineers (SAE). This automation levels defined by American Society of Automotive Engineers include five levels, that is, from level 0 to level 5.

Level 0 is defined as a level in which the user in driver's seat performs all of the driving tasks without an involvement of the system. Herein, driving tasks may include a steering operation, acceleration/deceleration operation, and the like. The driving tasks may also include monitoring a peripheral of the vehicle, such as a front area of the vehicle. Level 0 corresponds to a fully manual driving level. Level 1 is a level in which the system assists either the steering operation or the acceleration/deceleration operation. Level 2 is a level in which the system supports multiple operations among the steering operation and the acceleration/deceleration operation. The level 1 and the level 2 each corresponds to a driving assistance level.

Level 3 is a level in which the system performs all of the operation tasks within an operational design domain (ODD), while the operation authority is transferred from the system to the user in an emergency. The ODD defines conditions under which autonomous driving can be executed, such as a traveling on a highway. In the level 3, the user is required to respond quickly when the system requests a driving change. In addition, instead of the user, an operator existing outside of the vehicle may take over the driving operation instead of the system. The level 3 corresponds to a conditional autonomous driving.

Level 4 is a level in which the system is capable of performing all of the driving tasks, except under specific circumstances such as autonomous driving unsupported roads, extreme environments, etc. Level 4 corresponds to a level in which the system performs all of the driving tasks within the ODD. The level 4 corresponds to a highly automated autonomous driving.

Level 5 is a level in which the system is capable of performing all of driving tasks in any situation. The level 5 corresponds to a fully autonomous driving. The level 3 to the level 5 correspond to autonomous driving. The level 3 to the level 5 can also be referred to as an automated driving that automatically execute all controls related to driving of vehicle. The target level of the autonomous driving in the present disclosure may be set to level 3 or higher, or may be level 4 or higher. Hereinafter, a case where the vehicle control system 1 is applied to the vehicle 2, which has an ability of executing autonomous driving in level 5, will be described as an example.

In the autonomous driving of the vehicle 2, the vehicle 2 is automatically driven with a set driving characteristic. Here, the driving characteristics include various values and degrees indicating a movement of the vehicle 2 related to a driving of the vehicle 2. The driving characteristic includes, as an example, an inter-vehicle distance characteristic. The inter-vehicle distance characteristic is related to a distance to a front vehicle in a situation where the vehicle 2 travels following the front vehicle or when the vehicle stops travelling behind the front vehicle.

The driving characteristic includes, as an example, a deceleration characteristic. The deceleration characteristics are various characteristics related to the deceleration of the vehicle 2. The deceleration characteristic may include a deceleration value characteristic relating to a value of the deceleration which is indicated by a negative acceleration value when decelerating the vehicle 2. The deceleration characteristic may include a deceleration time characteristic which is a characteristic relating to a time at which deceleration of the vehicle 2 is started. The deceleration characteristics may include characteristic other than the above-described characteristics.

The driving characteristic includes, as an example, an acceleration characteristic. The acceleration characteristics are various characteristics related to the acceleration of the vehicle 2. The acceleration characteristic may include an acceleration value characteristic relating to a value of acceleration when accelerating the vehicle 2. The acceleration characteristic may include an acceleration time characteristic which is a characteristic relating to a time at which acceleration of the vehicle 2 is started. The acceleration characteristics may include characteristic other than the above-described characteristics.

The driving characteristic includes, as an example, a lateral distance characteristic. The lateral distance characteristic is related to a lateral distance from the vehicle 2 to another vehicle, a wall, or the like in a lateral direction, that is, left-right direction. The lateral distance characteristic may include a characteristic relating to a distance between a side surface of the vehicle 2 and a wall surface of a garage when the vehicle enters the garage. As another example, the lateral distance characteristic may include a characteristic relating to a distance from the vehicle 2 to a truck when the vehicle 2 and the truck are travelling in parallel.

The driving characteristic includes, as an example, a temporary stop characteristic. The temporary stop characteristic is a characteristic related to a voluntary temporary stop at a point to check left and right for any obstacles although the vehicle 2 is not required to stop, for example, by a traffic sign at the point.

The driving characteristics may include characteristics other than the above-described characteristics. Further, the driving characteristics do not have to include all of the above-described characteristics. Alternatively, the driving characteristics may include at least a part of the above-described characteristics.

During the autonomous driving, the driving characteristics of autonomous driving may differ from the driving characteristics expected by the occupant. For example, a driver who drives slowly in manual driving may feel stressful to a quick driving executed by the autonomous driving. Alternatively, a driver who drives quickly in manual driving may feel stressful to a slow driving executed by the autonomous driving. As described above, when the driving characteristics of the autonomous driving is slightly different from the driving characteristics preferred by the occupant, the occupant may feel a sense of discomfort during the autonomous driving, and the riding comfort and user experience may be deteriorated. Thus, it is very important to match the driving characteristics of autonomous driving with the driving characteristics of user preference in order to improve the riding comfort and user experience.

The vehicle control system 1 includes a vehicle control apparatus 70, a mobile terminal 3, and an external server 4 that are communicably connected to one another via a wide area wireless communication network NW. However, the vehicle control system 1 may include only the vehicle control apparatus 70, without including the mobile terminal 3 and the external server 4. As another example, a stationary information processing terminal may be used instead of the mobile terminal 3.

The mobile terminal 3 is an information processing terminal, such as a smartphone. The smartphone is also called as a multifunctional mobile phone. The mobile terminal 3 has an operation display screen that accepts operations made by the user and displays information to the user. The following will describe a case where a user who owns the mobile terminal 3 is boarding on the vehicle 2 as the occupant. The mobile terminal 3 having the operation display screen is provided as an example of a display device. The occupant corresponds to an example of the user.

The communication between the mobile terminal 3 and the vehicle control apparatus 70 may adopt a short-range wireless communication or wired communication. Alternatively, the communication between the mobile terminal 3 and the vehicle control apparatus 70 may be executed by the wide area wireless communication network NW. The user can change, by operating the mobile terminal 3, various settings related to autonomous driving executed by the vehicle control apparatus 70.

The external server 4 is provided outside of the vehicle 2. The external server 4 includes a database storing various information to be used in the autonomous driving of the vehicle 2, such as a driving characteristic group that will be described later. The information stored in the external server 4 can be updated by a manager of the external server. For example, a server provided on the cloud can be adopted as the external server 4.

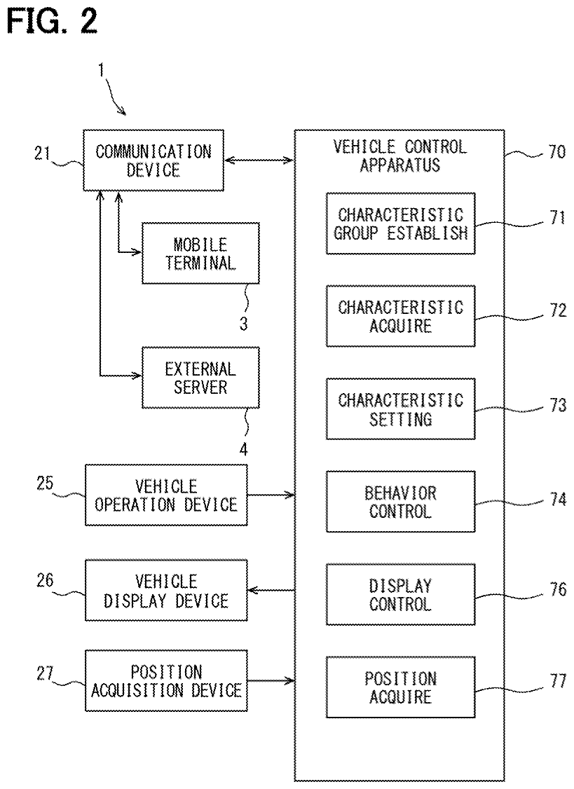

As shown in FIG. 2, the vehicle control apparatus 70 is connected to a communication device 21. The communication device 21 is configured to communicate with an information processing terminal disposed outside of the vehicle control apparatus 70. The communication device 21 is configured to communicate with the mobile terminal 3 and the external server 4. The communication device 21 receives information transmitted from the mobile terminal 3 and the external server 4. The communication device 21 transmits information to the mobile terminal 3 and the external server 4. The vehicle control apparatus 70 acquires the information received by the communication device 21. The vehicle control apparatus 70 controls the communication device 21 to transmit information, which is required to be sent to the mobile terminal 3 and the external server 4.

The vehicle control apparatus 70 is connected to a vehicle operation device 25, a vehicle display device 26, and a position acquisition device 27. The vehicle operation device 25 is a device mounted on the vehicle 2. The occupant can change, by operating the vehicle operation device 25, various settings related to the autonomous driving executed by the vehicle control apparatus 70. The vehicle control apparatus 70 acquires an operation result of the vehicle operation device 25 operated by the occupant. Alternatively, the operation function provided by the vehicle operation device 25 may be performed by the mobile terminal 3.

The vehicle display device 26 is a device mounted on the vehicle 2. The vehicle display device 26 is a device that displays various information related to vehicle control to the occupant of the vehicle 2. The vehicle control apparatus 70 controls the vehicle display device 26 to display necessary information. The display function of the vehicle display device 26 may be performed by the mobile terminal 3. The vehicle display device 26 corresponds to an example of the display device.

The position acquisition device 27 is a device that acquires a current area of the vehicle 2 by successively detecting a current position of the vehicle 2. The current area is defined as an area including the current position of the vehicle 2 among multiple areas divided, in advance, on a map. Alternatively, the current area may be specified based on the road on which the vehicle 2 is currently traveling. As the position acquisition device 27, an advanced driver-assistance system (ADAS) locator equipped with a global navigation satellite system (GNSS) receiver and a map database may be adopted.

The vehicle control apparatus 70 includes a characteristic group establishment unit 71, a characteristic acquisition unit 72, a characteristic setting unit 73, and a behavior control unit 74. The characteristic group establishment unit 71 establishes a driving characteristic group including multiple records of driving characteristic information that enables autonomous driving. The driving characteristic information is information that indicates a specific driving characteristic that can be set as a driving characteristic of autonomous driving. In autonomous driving, driving control is executed based on the set driving characteristic information. Thus, it is required that driving characteristic that enables a comfortable driving is set as the driving characteristic information.

The driving characteristic information may include numerical information indicating the driving characteristic in numerical manner and/or degree information indicating the driving characteristic using a degree. As an example, the numerical information included in the driving characteristic information may be a set numerical value of the inter-vehicle distance characteristic. More specifically, the numerical information may be a target numerical value of the inter-vehicle distance, which changes corresponding to the vehicle speed. As an example, the degree information included in the driving characteristic information may be degree information of the inter-vehicle distance characteristic. More specifically, the degree information may be shown in five degrees including long, slightly long, standard, slightly short, and short.

The driving characteristic information includes general characteristic information and area characteristic information. The general characteristic information is related to a classification, such as a specific vehicle type, a specific person, or a specific weather condition. The area characteristic information is driving characteristic information acquired corresponding to the current area of the vehicle 2. The general characteristic information indicates the driving characteristic information determined regardless of the area, and the area characteristic information indicates the driving characteristic information associated with a specific area.

The area characteristic information includes driving characteristic information of a high risk section. The high risk section requires a special attention during driving. The high risk section may include a section where children often appear, an intersection with poor visibility, or a neighborhood who performs violent driving. A local resident may have some information about the high risk section. However, it is difficult for a non-local resident to obtain information about the high risk section.

For example, a route to a school may be set as the high risk section since many children uses the route. The route to a school is also referred to as a school mute. However, it is difficult for a driver who drives the route for the first time to determine whether the route is a school route. In particular, it is difficult to recognize where a route is the school route used by only a small number of children group or an individual route leading to a meeting place of the children group. For this reason, the driver who drives the route for the first time cannot recognize that the route is a high risk section unless a signboard that requires attention to the children appearance is installed. In such section, local residents can understand that the section is the school route, and drive the vehicle in consideration of the children appearance by decelerating the vehicle during traveling on the school route.

For another example, a curve having a poor visibility may be set as the high risk section. It is difficult to confirm whether the visibility from an end of the curve is good or bad before actually entering the curve. In such curve, local residents can understand in advance that the curve has a poor visibility. Thus, it is possible to drive in consideration of road condition of the curve by decelerating the vehicle to a lower speed during traveling on the curve.

The area characteristic information includes the driving characteristic of local residents who are likely to perform manual driving since they have information about the high risk section in advance. An exemplary characteristic included in the area characteristic information is a long inter-vehicle distance characteristic in preparation for a sudden braking of the vehicle to be made on a specific road. An exemplary characteristic included in the area characteristic information is a deceleration characteristic that decelerates on a specific road used as the school route. An exemplary characteristic included in the area characteristic information is an acceleration characteristic that starts the vehicle with a low acceleration on a specific road used as the school route. An exemplary characteristic included in the area characteristic information is a temporary stop characteristic that voluntarily stops the vehicle at a specific intersection although the stop at the intersection is not required by a traffic sign or the like. The area characteristic information corresponds to driving characteristic information for performing a driving operation similar to the driving operation performed by the local residents who are familiar with the local circumstances during driving in the high risk section that is known by the local residents.

The number of specific sections included in the area characteristic information is not limited to one. For example, multiple records of characteristic information corresponding to multiple specific sections may be included in one record of area characteristic information. In this case, one specific section may correspond to the school route and another specific section may correspond to an intersection.

The general characteristic information stored in the external server 4 includes multiple records of general characteristic information related to different vehicle types, different external environments, and different drivers. Examples of different vehicle types include a case where a size and a weight of the vehicle 2 is different from one another, such as a large vehicle and a small vehicle. Even when the vehicles 2 have the same size, when the performances of the engines and brakes equipped to the vehicles are different from one another, different general characteristic information may be stored for respective vehicles in the external server 4.

Examples of different external environments include different weather conditions, such as sunny weather, rainy weather, and snowfall. The different external environments also include cases where the road surface conditions are different, such as paved road and unpaved road.

Examples of different drivers include drivers having different driving skills and abilities, such as professional drivers and non-professional drivers. The different drivers also include a case where the driver is different among a driver group in which the occupant knows the driving characteristic of the driver to a certain extent, such as parents or relatives of the occupant. The different drivers also include a case where the driver is different among a driver group in which the occupant does not know the driving characteristic of the driver, such as favorite celebrities or racing drivers.

The characteristic group establishment unit 71 extracts the driving characteristic information selectable in the current autonomous driving from the multiple records of driving characteristic information stored in the external server 4, and establishes the driving characteristic group to include the extracted driving characteristic information. For example, the driving characteristic information of a third party set to be private is not included in the driving characteristic group established by the characteristic group establishment unit 71. As a result, the driving characteristic information of the parent of another person is not included in the driving characteristic group. The characteristic group establishment unit 71 establishes a general characteristic group, which is a driving characteristic group including multiple records of general characteristic information. The characteristic group establishment unit 71 also establishes an area characteristic group, which is a driving characteristic group including multiple records of area characteristic information.

The general characteristic group includes different general characteristic information corresponding to different classifications described above. For example, the general characteristic information of a professional driver may be divided into different multiple records of general characteristic information. For example, the general characteristic information of the professional driver may include a case where a professional driver manually drives a small vehicle in sunny weather.

The area characteristic group includes multiple records of area characteristic information in different areas. The area characteristic group does not have to include respective records of area characteristic information corresponding to all preset areas. That is, a certain area may not have corresponding area characteristic information. A size of the area can be set as appropriate. For example, only one road may be set in one area. In this case, the characteristic information is set for the one road.

The general characteristic information may include inter-vehicle distance characteristic, deceleration characteristic, acceleration characteristic, and lateral distance characteristic among various types of driving characteristics. The area characteristic information may include the inter-vehicle distance characteristic, the deceleration characteristic, the acceleration characteristic, and the temporary stop characteristic among various types of driving characteristics. The general characteristic information and the area characteristic information include information items of common driving characteristics and information items of driving characteristics that are different from one another. However, the information items of the driving characteristics included in the general characteristic information and the area characteristic information are not limited to the above-described examples.

The driving characteristic information may be generated by machine learning based on the driving characteristics acquired from multiple driving data items. The following will describe a generation of the driving characteristic information of a professional driver as the general characteristic information. In this case, machine learning may be performed based on the driving characteristics of multiple professional drivers when the professional drivers perform manual driving. Alternatively, machine learning may be performed based on the driving characteristic of one professional driver for multiple times of driving on different types of roads. This configuration enables a generation of the driving characteristic information of a professional driver by generalizing driving characteristics of the professional driver.

The following will describe a generation of the area characteristic information. In this case, machine learning may be performed based on the driving characteristics of unspecified number of drivers within a specific area in a case where the drivers perform manual driving. Alternatively, the machine learning may be performed based on driving characteristics of drivers, which are narrowed by different criteria other than the area. For example, machine learning may be performed based only on the driving characteristics of professional drivers, such as taxi driver who perform manual driving in the specific area. According to this configuration, it is possible to prevent the data for machine learning from including the driving characteristic of a driver having low driving skill.

The characteristic acquisition unit 72 acquires driving characteristic information used for autonomous driving from the driving characteristic group including multiple driving characteristic information items. Hereinafter, information item is used for describe one record of information. More specifically, the driving characteristic information to be used in the autonomous driving is selected and acquired from the driving characteristic group, which is downloaded from the external server 4. The characteristic acquisition unit 72 acquires general characteristic information selected by the occupant from the general characteristic group. The characteristic acquisition unit 72 acquires area characteristic information corresponding to the current area of the vehicle 2 from the area characteristic group.

The characteristic setting unit 73 sets the driving characteristic information acquired by the characteristic acquisition unit 72 as the driving characteristic of the autonomous driving. That is, the characteristic setting unit 73 installs the driving characteristic information, which is downloaded by the characteristic acquisition unit 72 from the external server 4. For example, when the characteristic acquisition unit 72 acquires general characteristic information of a professional driver, the driving characteristic is set based on the driving characteristic information of the professional driver. As a result, in the autonomous driving, the driving of a professional driver can be reproduced. When the characteristic acquisition unit 72 acquires the area characteristic information of the current area of the vehicle 2, the driving characteristic is set based on the acquired area characteristic information. As a result, in the autonomous driving, the driving performed by the local residents with consideration of the high risk section can be reproduced.

The behavior control unit 74 controls a behavior device. The behavior device includes a power source of the vehicle, a brake of the vehicle, and a steering mechanism of the vehicle 2 as examples. The behavior control unit 74 executes the autonomous driving according to the driving characteristics set by the characteristic setting unit 73.

The vehicle control apparatus 70 further includes a display control unit 76 and a position acquisition unit 77. The display control unit 76 controls the vehicle display device 26 to display information, such as the driving characteristic group. The position acquisition unit 77 acquires the current area of the vehicle 2 using the position acquisition device 27.

The following will describe a control including autonomous driving of the vehicle. The following will describe a case where the occupant operates the vehicle operation device 25 to select the driving characteristic information as an example. Alternatively, instead of the vehicle operation device 25 and the vehicle display device 26, the occupant may use the mobile terminal 3 to select the driving characteristic information.

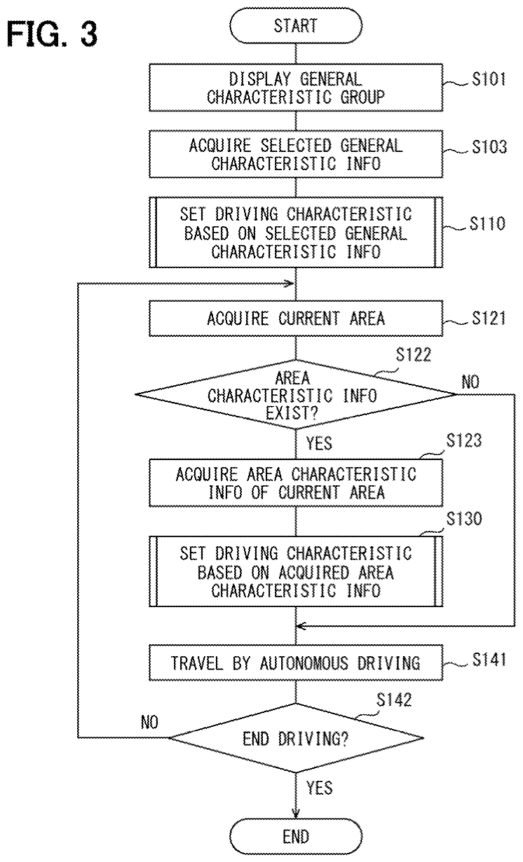

In FIG. 3, when the vehicle control apparatus 70 starts control including autonomous driving in response to a start operation made by the user or the like, the display control unit 76 displays a general characteristic group on the vehicle display device 26 in S101. For example, different general characteristic information items of the drivers, such as a general characteristic information item of the occupant, a general characteristic information item of parent of the occupant, a general characteristic information item of a professional driver may be displayed as the general characteristic information group.

Instead of directly displaying the general characteristic group on the vehicle display device 26, information for selecting the general characteristic item may be displayed as substantial display of the general characteristic group. More specifically, the general characteristic group may be displayed by displaying candidate names of drivers that can be selected, such as a name of the occupant, a name of the occupant's parent, a name of a professional driver. The occupant can select a favorite general characteristic information item from the displayed general characteristic group.

The display control unit 76 displays, on the vehicle display device 26, a difference between a reference driving characteristic and a driving characteristic corresponding to the general characteristic information item of each selection candidate. For example, when the reference driving characteristic is a driving characteristic defined in the initial setting, the difference between the driving characteristic defined in the initial setting and the general characteristic information of each selection candidate may be displayed. As a result, the occupant is possible to know about the difference which is to be occurred in response to a start of the autonomous driving when the general characteristic information of each selection candidate is selected compared with the reference driving characteristic. Instead of setting the initial setting as the reference driving characteristic, the driving characteristic of the occupant may be set as the reference driving characteristic. According to this configuration, it is easy for the occupant to concretely imagine how the driving characteristic will change from the driving characteristic usually performed by himself/herself.

The difference between the reference driving characteristic and the selection candidate driving characteristic may be displayed using the degree of each driving characteristic. The following will describe a case where the initial setting of driving characteristic information are set as the reference driving characteristic items. In this case, the general characteristic information of a professional driver is displayed as a slightly long inter-vehicle distance characteristic, a standard deceleration characteristic, a slightly quick acceleration characteristic, a standard lateral distance characteristic. This configuration enables the occupant to grasp the difference of the selection candidate driving characteristic from the reference driving characteristic of autonomous driving, that is, the initial setting of autonomous driving when the occupant selects the general driving characteristic information. Alternatively, each driving characteristic may be displayed with numerical information instead of the degree information.

After the general characteristic information is selected from the general characteristic group by the occupant, a screen for inputting information such as the current weather and the pavement condition of the road surface may be additionally displayed. In this case, the occupant is required to input information such as weather. For example, the occupant selects a professional driver as the driver, sunny weather as the weather information, and paved road as the road surface information. In this case, general characteristic information corresponding to a case where a professional driver performs driving on a paved road in sunny weather is selected.

Instead of requiring the occupant to input the weather information and the road surface information, the information such as the weather corresponding to the current area may be acquired by communication with an outside source. Further, preset information may be automatically acquired in order to prevent the occupant from erroneously selecting the predetermined information about the vehicle 2, such as the vehicle type. By acquiring the vehicle type information, the general characteristic information corresponding to a case where a professional driver drives a small vehicle on a paved road in sunny weather can be selected.

Information items, such as the general characteristic group to be displayed on the vehicle display device 26 is stored in the external server 4. The manager who manages the information of the general characteristic group stores the latest information in the external server 4. Thus, the occupant can select the favorite general characteristic information item from the latest general characteristic group. After displaying the general characteristic group, the process proceeds to S103.

In S103, the characteristic acquisition unit 72 acquires the selected general characteristic information item from the external server 4. After acquiring the general characteristic information item, the process proceeds to S110. The process executed in S103 corresponds to an example of a characteristic acquisition step and a characteristic acquisition process.

In S110, the characteristic setting unit 73 sets the driving characteristic of the autonomous driving using the acquired general characteristic information item. The characteristic setting unit 73 corresponds to a characteristic update unit that updates the driving characteristic of autonomous driving from the initial setting to the driving characteristic corresponding to the selected general characteristic information. Details of a driving characteristic setting method using the general characteristic information will be described below. The process executed in S110 corresponds to an example of a characteristic setting step and a characteristic setting process.

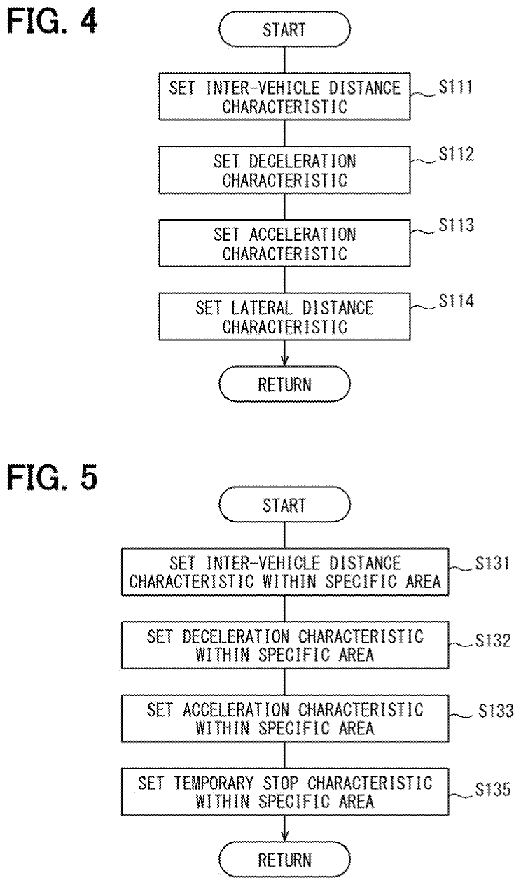

In FIG. 4, the characteristic setting unit 73 sets the inter-vehicle distance characteristic for autonomous driving in S111. More specifically, the inter-vehicle distance characteristic set in the initial setting of the autonomous driving is updated to the inter-vehicle distance characteristic of the selected general characteristic information. After updating the inter-vehicle distance characteristic, the process proceeds to S112.

In S112, the characteristic setting unit 73 sets the deceleration characteristic of the autonomous driving. More specifically, the deceleration characteristic set in the initial setting of the autonomous driving is updated to the deceleration characteristic of the selected general characteristic information. As described above, the deceleration characteristic includes the deceleration value characteristic and the deceleration time characteristic. Thus, multiple deceleration related characteristics are set in S112. After updating the deceleration characteristic, the process proceeds to S113.

In S113, the characteristic setting unit 73 sets the acceleration characteristic of the autonomous driving. More specifically, the acceleration characteristic set in the initial setting of the autonomous driving is updated to the acceleration characteristic of the selected general characteristic information. As described above, the acceleration characteristic includes the acceleration value characteristic and the acceleration time characteristic. Thus, multiple acceleration related characteristics are set in S113. After updating the acceleration characteristic, the process proceeds to S114.

In S114, the characteristic setting unit 73 sets the lateral-distance characteristic of the autonomous driving. More specifically, the lateral distance characteristic set in the initial setting of the autonomous driving is updated to the lateral distance characteristic of the selected general characteristic information. After updating the lateral distance characteristic, the process proceeds to S121.

In S121, the position acquisition unit 77 acquires the current area of the vehicle 2. The current area of the vehicle 2 acquires, as the current area, an area corresponding to the current position of the vehicle 2 based on the current position of the vehicle 2 specified by the position acquisition device 27 and the map data. After acquiring the current area, the process proceeds to S122.

In S122, the vehicle control apparatus 70 determines an existence of the area characteristic information corresponding to the current area of the vehicle 2. More specifically, when the area characteristic information corresponding to the current area exists in the area characteristic group, the vehicle control apparatus determine that the area characteristic information exists, and the process proceeds to S123. When the area characteristic information corresponding to the current area does not exist in the area characteristic group, the vehicle control apparatus determine that the area characteristic information does not exist, and the process proceeds to S141.

In S123, the characteristic acquisition unit 72 acquires the area characteristic information corresponding to the current area of the vehicle 2 from the area characteristic group. The area characteristic information is set for each area. Thus, every time the vehicle 2 moves and the current area changes, the area characteristic information corresponding to the updated current area is acquired.

The information of the area characteristic group is stored in the external server 4. The manager who manages the information of the area characteristic group stores the latest information in the external server 4. Thus, the occupant can select the proper area characteristic information item from the latest area characteristic group. After acquiring the area characteristic information, the process proceeds to S130.

In S130, the characteristic setting unit 73 sets the driving characteristic of the autonomous driving using the acquired area characteristic information. The characteristic setting unit 73 corresponds to a characteristic update unit that updates the driving characteristic of autonomous driving from the initial setting or the general characteristic information to the driving characteristic corresponding to the selected area characteristic information. Details of the driving characteristic setting method using the area characteristic information will be described below.

In FIG. 5, the characteristic setting unit 73 sets the inter-vehicle distance characteristic within the specific section in S131. More specifically, when the vehicle travels in the specific section, the inter-vehicle distance characteristic of the general characteristic information is changed to the inter-vehicle distance characteristic of the area characteristic information. When the vehicle travels a section other than the specific section, a state in which the inter-vehicle distance characteristic of the general characteristic information may be maintained. In the specific section, the autonomous driving is performed by the inter-vehicle distance characteristic of the area characteristic information. In a section other than the specific section, the autonomous driving is performed by the inter-vehicle distance characteristic of the general characteristic information. As a result, within the high risk section, it is possible to perform autonomous driving with consideration of the circumstances of the area by maintaining a longer inter-vehicle distance compared with other sections. After updating the inter-vehicle distance characteristic, the process proceeds to S132.

In S132, the characteristic setting unit 73 sets the deceleration characteristic of the autonomous driving in the specific section. More specifically, when the vehicle travels in the specific section, the deceleration characteristic of the general characteristic information is changed to the deceleration characteristic of the area characteristic information. When the vehicle travels a section other than the specific section, a state in which the deceleration characteristic of the general characteristic information may be maintained. In the specific section, the autonomous driving is performed by the deceleration characteristic of the area characteristic information. In a section other than the specific section, the autonomous driving is performed by the deceleration characteristic of the general characteristic information. As a result, within the high risk section, it is possible to perform autonomous driving with consideration of the circumstances of the area by activating a deceleration at an earlier time compared with other sections. After updating the deceleration characteristic, the process proceeds to S133.

In S133, the characteristic setting unit 73 sets the acceleration characteristic of the autonomous driving in the specific section. More specifically, when the vehicle travels in the specific section, the acceleration characteristic of the general characteristic information is changed to the acceleration characteristic of the area characteristic information. When the vehicle travels a section other than the specific section, a state in which the acceleration characteristic of the general characteristic information may be maintained. In the specific section, the autonomous driving is performed by the acceleration characteristic of the area characteristic information. In a section other than the specific section, the autonomous driving is performed by the acceleration characteristic of the general characteristic information. As a result, within the high risk section, it is possible to perform autonomous driving with consideration of the circumstances of the area by decreasing the acceleration when starting the vehicle compared with other sections. After updating the acceleration characteristic, the process proceeds to S135.

In S135, the characteristic setting unit 73 sets the temporary stop characteristic of the autonomous driving in the specific section. More specifically, when the vehicle travels in the specific section, the temporary stop characteristic of the initial setting is changed to the temporary stop characteristic of the area characteristic information. When the vehicle travels a section other than the specific section, a state in which the temporary stop characteristic of the initial setting may be maintained. In the specific section, the autonomous driving is performed by the temporary stop characteristic of the area characteristic information. In a section other than the specific section, the autonomous driving is performed by the temporary stop characteristic of the initial setting. As a result, within the high risk section, it is possible to perform autonomous driving with consideration of the circumstances of the area by voluntarily making a temporary stop at a point where the temporary stop is not required.

The following will describe a case where the specific section in the area characteristic information is the high risk section. In this case, by setting the driving characteristics of autonomous driving based on the area characteristic information, a travel time required from entering of the high risk section to exit from the high risk section is increased. For example, driving characteristics such as driving at a lower speed in the high risk section compared with other sections, increasing the number of temporary stops, or restricting sharp increase of the acceleration after the temporary stop may cause increase of travel time required to pass through the high risk section. After updating the temporary stop characteristic, the process proceeds to S141.

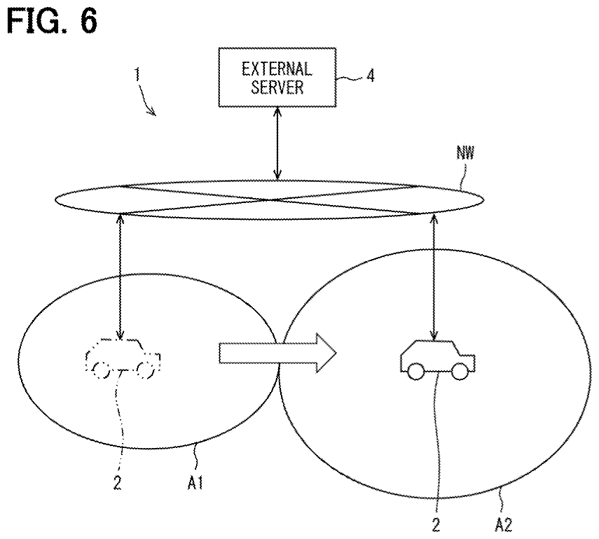

In S141, the behavior control unit 74 performs the autonomous driving of the vehicle 2. The current area of the vehicle 2 changes in accordance with the autonomous driving of the vehicle. FIG. 6 shows two different areas including a first area A1 and a second area A2. When the current area of the vehicle 2 changes from the first area A1 to the second area A2, the area characteristic information corresponding to the second area A2 is acquired instead of the area characteristic information corresponding to the first area A1. The first area A1 and the second area A2 may be set adjacent to one other. Alternatively, the first area A1 and the second area A2 may be set apart from one another. The vehicle control apparatus 70 resets the driving characteristic information of the autonomous driving based on the latest area characteristic information, and continues the traveling by autonomous driving. After traveling by autonomous driving, the process proceeds to S142.

In S142, the vehicle control apparatus 70 determines whether the autonomous driving of vehicle 2 is completed. When determining that the autonomous driving is completed, a series of controls including the autonomous driving is terminated. When determining that the autonomous driving is not yet completed, the process returns to S121. With this configuration, the driving characteristic information of the autonomous driving can be reset to the latest area characteristic information corresponding to the latest current area of the vehicle 2, and the vehicle can continue travelling by the autonomous driving.

After completing a series of controls including the autonomous driving, when partial driving operation is performed by the manual driving, the driving characteristic of manual driving is transmitted to the external server 4 as the driving characteristic information. At this time, the driving characteristic information is transmitted, to the external server 4, as data which is related to the area traveled by the manual driving. With this configuration, the latest driving characteristic of manual driving is reflected to the driving characteristic information of the driving characteristic group. More specifically, the driving characteristic information of the manual driving will be reflected as two information items which includes the general characteristic information item of the occupant and the area characteristic information about the area traveled by the manual driving. Further, since the data of manual driving is transmitted after the driving is completed, the autonomous driving process and the data transmission process can be executed at different times. Thus, it is possible to prevent the processing performed by the vehicle control apparatus 70 from being concentrated, and it is possible to prevent the processing load from being increased extremely and temporarily.

The time at which the driving characteristic of manual driving is transmitted to the external server 4 as the driving characteristic information is not limited to after the completion of driving. For example, the latest driving characteristic information may be transmitted to the external server 4 at any time during manual driving. According to this configuration, the driving characteristic information of manual driving can be reflected in the driving characteristic information included in the driving characteristic group at an earlier time.

When it is not necessary to reflect the driving characteristics of the manual driving executed by the occupant in the driving characteristics of the autonomous driving, the driving characteristics of the manual driving may not be transmitted to the external server 4 as the driving characteristic information. With this configuration, the amount of information in the communication between the external server 4 and the communication device 21 can be reduced, and the communication processing load can be reduced.

As described above, the occupant selects the general characteristic information from the general characteristic group by using the vehicle operation device 25 and the vehicle display device 26. The present disclosure is not limited to this configuration. As a method for selecting the general characteristic information, a method may be adopted in which the general characteristic group is displayed on the mobile terminal 3 and the user is allowed to operate the mobile terminal 3 to select the general characteristic information. In this case, the selected general characteristic information is acquired by receiving the operation result on the mobile terminal 3 via the communication device 21. With this configuration, the occupant can select favorite general characteristic information from the general characteristic group before boarding the vehicle 2. Thus, the occupant can start the autonomous driving more quickly in easy manner compared with a case where the occupant selects the general characteristic information after boarding on the vehicle.

As a method for selecting the general characteristic information, a method may be adopted in which a provider of vehicle sharing service operates a stationary information processing terminal, which corresponds to the mobile terminal 3, to select the general characteristic information. With this configuration, the vehicle sharing service provider can provide the user of the vehicle sharing service with autonomous driving that satisfies the driving characteristic information required by the user. For example, it is possible to set the most suitable driving characteristic information according to the weather condition at the reservation time, the degree of tire wear of the vehicle 2, and the like. Then, the user can perform autonomous driving with the driving characteristic information set by the service provider. Thus, it is possible to provide the vehicle sharing service with high added value. The service user corresponds to an example of the user. The service provider also corresponds to an example of the user.

The following will describe technical effects of the above-described embodiment. In the above-described embodiment, the characteristic setting unit 73 is configured to set the driving characteristic to be used in the autonomous driving with the acquired driving characteristic information item to be different from a driving characteristic of a manual driving performed by a user of the vehicle 2 With this configuration, the vehicle 2 can perform autonomous driving with the driving characteristic different from the driving characteristic of the manual driving performed by the user. With this configuration, it is possible to reproduce the autonomous driving with the user's selected driving characteristic, which is different from the driving characteristic of the manual driving performed by the user. Thus, it is possible to provide a vehicle control apparatus 70 capable of performing highly comfortable autonomous driving.

For example, in the autonomous driving, by reproducing the driving performed by the parents of occupant, it is possible to reproduce the feeling of driving that the occupant has been accustomed to for many years. Thus, in a case where the required or expected driving characteristic cannot be accurately reproduced by the occupant's own manual driving, the required driving can be accurately reproduced by using the general characteristic information stored in the external server 4.

The characteristic setting unit 73 sets, as the driving characteristic of the autonomous driving, the general characteristic information selected, by the user, from the general characteristic group that includes multiple general characteristic information items. That is, the characteristic setting unit 73 sets the driving characteristic to be used in the autonomous driving based on the driving characteristic information item that is selected by the user from multiple driving characteristic information items included in the driving characteristic group. Thus, the user can select a favorite driving characteristic information item from the multiple driving characteristic information items, and reflect the selected driving characteristic information item in the autonomous driving.

The driving characteristic group includes the driving characteristic information item that reproduces the manual driving performed by the user. Thus, in the autonomous driving, the user can select and reflect his/her favorite driving characteristic information from the driving characteristic information item corresponding to his/her own manual driving and the driving characteristic information items corresponding to manual driving operations performed by different drivers.

The driving characteristic group includes multiple driving characteristic information items of multiple drivers different from one another. Thus, in the autonomous driving, the user is possible to select and reflect favorite driving characteristic information item from the multiple driving characteristic information items corresponding to multiple drivers having different driving proficiencies and driving abilities.

The vehicle control apparatus 70 includes the display control unit 76 that displays, on the vehicle display device 26, the difference between the driving characteristic defined in the initial setting as a reference and the driving characteristic corresponding to the general characteristic information when the user selects the driving characteristic information. That is, the vehicle control apparatus 70 includes the display control unit 76 that displays, on the display device, the difference between the driving characteristic information item of each selection candidate and the reference driving characteristic. Thus, when the user is not clear about the driving characteristic information item of a selection candidate corresponds to what kind of driving characteristic, it is easy to imagine the content of the driving characteristic corresponding to the selection candidate.

The driving characteristic information item includes at least one of an inter-vehicle distance characteristic element, a deceleration characteristic element, an acceleration characteristic element, a lateral distance characteristic element, and a temporary stop characteristic element. Thus, among various driving characteristic elements, an element of driving characteristic that affects the riding comfort and user experience can be properly set by the user.

The driving characteristic information item is generated by machine learning based on multiple driving characteristics of manual driving operations performed by multiple drivers. Thus, it is possible to generate the driving characteristic information item that can accurately reproduce a specific driving performed by the manual driving of a specific driver.

The characteristic setting unit 73 sets, as the driving characteristic to be used in the autonomous driving, the area characteristic information item and the general characteristic information item. The area characteristic information item is the driving characteristic information item acquired corresponding to the current area of the vehicle. The current area of the vehicle is acquired by the position acquisition unit 77. The general characteristic information item is the driving characteristic information item that is acquired regardless of the current area of the vehicle. Thus, it is possible to acquire different types of driving characteristic information items, that is, the area characteristic information item and the general characteristic information item, and reflect the acquired driving characteristic information item in the driving characteristic of autonomous driving.

The area characteristic information item is generated by machine learning based on driving characteristics of multiple drivers who perform manual driving operations in the specific area. Thus, compared to a case where the high risk section of the specific area is extracted and the area characteristic information item is manually generated by analyzing the proper driving characteristic within the high risk section, the area characteristic information items that configure the area characteristic group can be generated in an easy manner. Thus, it is easy to secure a large number of the area characteristic information items that configure area characteristic group. In addition, it is easy to update the contents of the area characteristic information items that configure area characteristic group. In a case where the high risk section is no longer the high risk section or a new high risk section occurs, appropriate area characteristic information item can be generated to configure the area characteristic group. Thus, it is easy to update the area characteristic information items that configure the area characteristic group based on the latest state of the specific area.

The area characteristic information item may include the driving characteristic in which the vehicle voluntarily makes a temporary stop in the high risk section. The area characteristic information item may include the driving characteristic in which the vehicle decreases the speed in the high risk section to be lower than the initial setting speed. The area characteristic information item may include the driving characteristic in which a duration required for passing through the specific section, that is, a duration from an entrance to the specific section of the specific area to an exit from the specific section is longer than the duration determined by the initial setting of the autonomous driving. Thus, the driving in the specific section becomes more cautious compared with driving in other section.

The area characteristic information item includes at least one of an inter-vehicle distance characteristic element, a deceleration characteristic element, an acceleration characteristic element, and a temporary stop characteristic element. Thus, among various driving characteristic elements, an element of the driving characteristic that may affect acceleration/deceleration can be appropriately set within the specific area or the specific section.

When the current area changes, the characteristic setting unit 73 sets, as the driving characteristic to be used in the autonomous driving, the area characteristic information item corresponding to the current area after change. Thus, even when the position of the vehicle 2 is changed during the autonomous driving, it is possible to set the latest area characteristic information item corresponding to the updated current area.

When both of the area characteristic information item and the general characteristic information item are able to be set for a same element of the driving characteristic, the characteristic setting unit 73 sets the driving characteristic of the autonomous driving with the area characteristic information item by assigning a higher priority to the area characteristic information item than the general characteristic information item. Thus, in an area where the area characteristic information item exists, the autonomous driving can be performed by the driving characteristic of the area characteristic information item, and in an area where the area characteristic information item does not exist, the autonomous driving can be performed by the driving characteristic of the general characteristic information item. Thus, it is possible to perform highly comfortable autonomous driving by combining the general characteristic information item and the area characteristic information item.

The general characteristic information item does not include the temporary stop characteristic element, but the area characteristic information item includes the temporary stop characteristic item. That is, the area characteristic information item includes the driving characteristic item that is not included in the general characteristic information item. Thus, a certain driving characteristic can be set with the area characteristic information item although it is not set with the general characteristic information item. Alternatively, a certain driving characteristic can be set with the general characteristic information item although it is not set with the area characteristic information item.

In the above-described embodiment, the area characteristic information of the current area is automatically acquired in S123. An acquisition method of the area characteristic information is not limited to the above-described configuration. For example, multiple area characteristic information items may exist corresponding to the same area, and the occupant may select a favorite area characteristic information item from the multiple area characteristic information items corresponding to the current area. The multiple area characteristic information items may include the area characteristic information item of the parent of occupant, which is generated by machine learning based on the manual driving data of the parent of occupant, the area characteristic information item of a professional driver, which is generated by machine learning based on manual driving data of the professional driver, or the like. With this configuration, the occupant can set the driving characteristic of the autonomous driving using the favorite area characteristic information.

In the above-described embodiment, the area characteristic information corresponding to the current area is acquired every time the current area changes. An acquisition method of the area characteristic information is not limited to the above-described method. For example, a destination may be set before the start of autonomous driving, and multiple area characteristic information items along the route from the current position to the destination may be acquired in advance. With this configuration, it is possible to complete the download of the necessary area characteristic information items before start of the autonomous driving.

The above-described vehicle control method includes the characteristic setting step that sets the driving characteristic to be used in the autonomous driving based on the acquired driving characteristic information item to be different from a driving characteristic of a manual driving performed by the user of the vehicle. The above-described vehicle control program includes the characteristic setting process that sets the driving characteristic to be used in the autonomous driving based on the acquired driving characteristic information item to be different from a driving characteristic of a manual driving performed by the user of the vehicle. With this configuration, the vehicle 2 can perform autonomous driving with the driving characteristic different from the driving characteristic of the manual driving performed by the user. With this configuration, it is possible to reproduce the autonomous driving with the user's selected driving characteristic, which is different from the driving characteristic of the manual driving performed by the user. With the vehicle control method and the vehicle control program, it is possible to provide a highly comfortable autonomous driving.

### Second Embodiment

The second embodiment is a modification of the above-described first embodiment. In the second embodiment, the characteristic acquisition unit 72 acquires the driving characteristic information corresponding to a current time from multiple driving characteristic information items that area different from one another depending on time information.

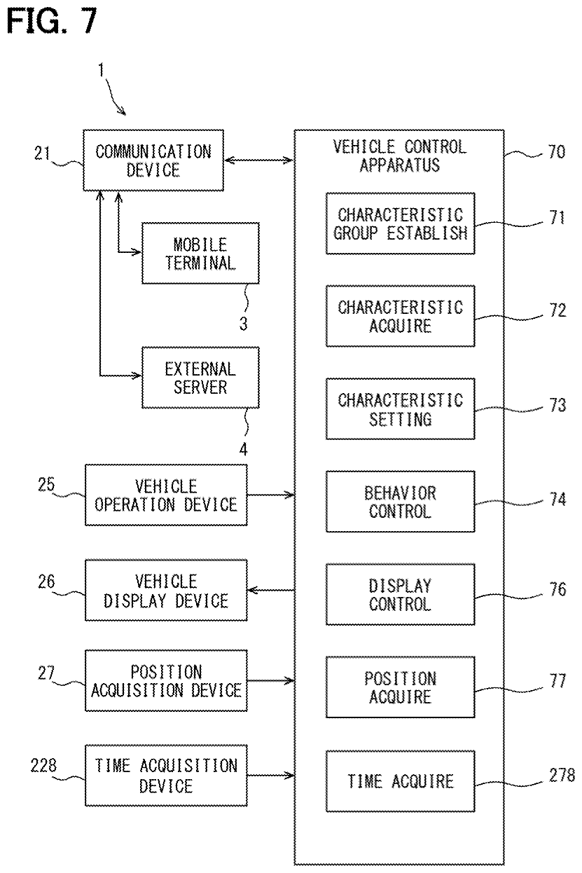

As shown in FIG. 7, the vehicle control apparatus 70 is connected to a time acquisition device 228. The time acquisition device 228 is configured to acquire the current time. The vehicle control apparatus 70 acquires the information received by the communication device 21. The vehicle control apparatus 70 includes a time acquisition unit 278. The time acquisition unit 278 acquires the current time using the time acquisition device 228.

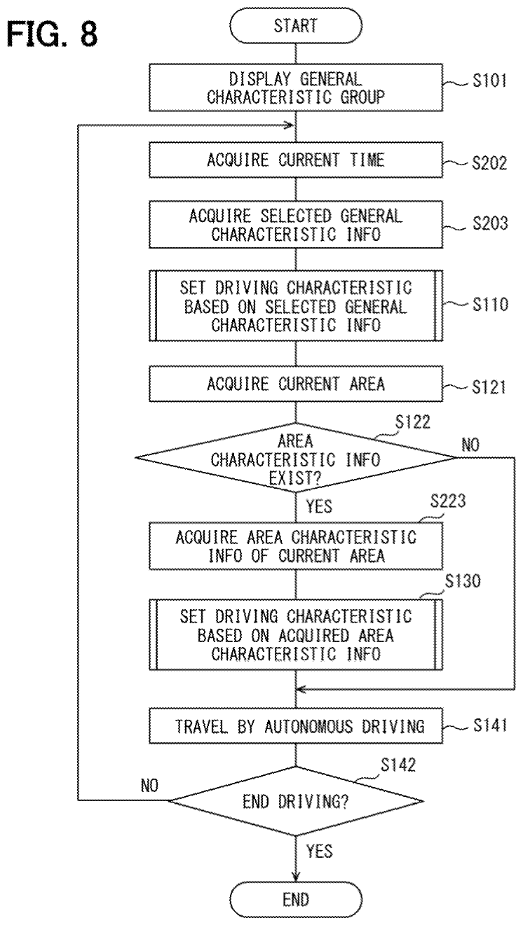

In FIG. 8, when the control including the autonomous driving starts, the display control unit 76 displays the general characteristic group on the vehicle display device 26 in S101. The occupant selects a favorite general characteristic information item from the displayed general characteristic group. Then, the process proceeds to S202.

In S202, the time acquisition unit 278 acquires the current time. After acquiring the current time, the process determines whether the current time of autonomous driving is included in morning time segment, a noon time segment, a night time segment, or a midnight time segment. The driving characteristic may change depending on the time segment in which the driving is performed. For example, in the morning time segment, many people drive the vehicles for commuting purposes, and it is estimated that many drivers may drive with limited time. For this reason, driving characteristic that increases the inter-vehicle distance compared with the daytime can be set as the general characteristic information in the morning time segment.

The division of the time segments may be properly set under a condition that the driving characteristics can be set different from one another. The division of the time segments is not limited to the above-described four time segments. For example, the time segments may be less than four segments, such as daytime segment and nighttime segment. For example, the time segments may be more than four segments, such as adding an evening time segment to the above-described four time segments. The day on which the autonomous driving to be performed may be determined based on date information included in the current time. For example, the day on which the autonomous driving to be performed may be determined to be a weekday or a holiday. The season of the day on which the autonomous driving to be performed may be determined from the date information included in the current time. After acquiring the current time, the process proceeds to S203.

In S203, the characteristic acquisition unit 72 acquires the selected general characteristic information item from the external server 4. The general characteristic information is selected based on both of the driving characteristic information selected by the occupant and the information automatically selected corresponding to the current time. For example, when the occupant selects a professional driver and the time segment of the current time is morning time segment, the general characteristic information of the professional driver in the morning time segment is selected. When the current time further includes the date information indicating the weekday, the general characteristic information of a professional driver on a weekday morning is selected. After acquiring the selection result of the general characteristic information, the process proceeds to S110. In S110, the driving characteristic of the autonomous driving is set by the acquired general characteristic information. Then, the process proceeds to S121 to acquire the current area. Then, the process proceeds to S122. In S122, when determining that the area characteristic information corresponding to the current area exists, the process proceeds to S223. The process executed in S203 corresponds to an example of a characteristic acquisition step and a characteristic acquisition process.

In S223, the characteristic acquisition unit 72 acquires the area characteristic information corresponding to the current area and the current area from the area characteristic group. The area characteristic information to be acquired is set for each area and time segment. Thus, every time the vehicle 2 moves and the current area changes, the area characteristic information corresponding to the updated current area is acquired. Further, every time the time elapses and the current time changes, the area characteristic information corresponding to the time segment of the updated current time is acquired. For example, when the current area is the first area A1 and the time segment is the morning time segment, the area characteristic information in the first area A1 during morning time segment is acquired. After acquiring the area characteristic information, the process proceeds to S130.

In S130, the driving characteristic of the autonomous driving is set by the acquired area characteristic information. Then, the process proceeds to S141, and the vehicle travels by the autonomous driving. Then, the process proceeds to S142, and determines whether the autonomous driving of the vehicle 2 is completed. When determining that the autonomous driving is completed, a series of controls including the autonomous driving is terminated. When determining that the autonomous driving is not yet completed, the process returns to S202. As a result, the current time and the current area are newly reacquired. Based on the latest current time and latest current area that are newly required, the driving characteristic of autonomous driving can be updated with the newly required driving characteristic information. Thus, the general characteristic information selected according to the current time can be updated, and the area characteristic information selected according to the current time and the current area can be updated.

The following will describe technical effects of the above-described embodiment. According to the present embodiment, among multiple driving characteristic information items different from one another depending on the time information, the characteristic setting unit 73 sets the driving characteristic to be used in the autonomous driving with the driving characteristic information item, which corresponds to the current time acquired by the time acquisition unit 278. Thus, it is possible to acquire the driving characteristic information item according to the current time, and set the acquired driving characteristic information item as the driving characteristic of the autonomous driving.

### Other Embodiments

The disclosure in this specification and drawings is not limited to the exemplified embodiments. The present disclosure includes embodiments described above and modifications of the above-described embodiments made by a person skilled in the art. For example, the present disclosure is not limited to a combination of the components and/or elements described in the embodiments. The present disclosure may be executed by various different combinations. The present disclosure may include additional configuration that can be added to the above-described embodiments. The present disclosure also includes modifications which include partial components/elements of the above-described embodiments. The present disclosure also includes replacement or combination of components and/or elements between one embodiment and another. The technical scope disclosed in the present disclosure is not limited to the above-described embodiments. It should be understood that some disclosed technical ranges are indicated by description of claims, and includes every modification within the equivalent meaning and the scope of description of claims.

The disclosure in the specification, drawings and the like is not limited by the description of the claims. The disclosures in the specification, the drawings, and the like includes the technical ideas described in the claims, and further extend to a wider variety of technical ideas than those described in the claims. Thus, various technical ideas can be extracted from the disclosure of the specification, the drawings and the like without being limited to the description of the present disclosure.

The control unit and method thereof according to the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits. The technique for realizing the functions of each functional unit included in the apparatus or the method thereof does not necessarily need to include software, and all the functions may be realized using one or more hardware circuits. Further, the computer program may be stored, as a program product, in a computer-readable non-transitory tangible storage medium as instructions to be executed by a computer.

What is claimed is:

1. A vehicle control apparatus controlling an execution of an autonomous driving of a vehicle, the vehicle control apparatus comprising:
a characteristic acquisition unit that acquires a driving characteristic information item indicating a numerical value or a degree of a driving characteristic to be used in an autonomous driving of the vehicle; and
a characteristic setting unit that sets the driving characteristic to be used in the autonomous driving of the vehicle with the driving characteristic information item acquired by the characteristic acquisition unit,
wherein the characteristic setting unit sets the driving characteristic to be used in the autonomous driving with the driving characteristic information item that is acquired to be different from a driving characteristic of a manual driving operation performed by a user of the vehicle.

2. The vehicle control apparatus according to claim 1, wherein
the characteristic setting unit sets the driving characteristic to be used in the autonomous driving with the driving characteristic information item that is selected by the user from multiple driving characteristic information items included in a driving characteristic group.

3. The vehicle control apparatus according to claim 2, wherein
the driving characteristic group includes a driving characteristic information item that reproduces the driving characteristic of the manual driving operation performed by the user of the vehicle.

4. The vehicle control apparatus according to claim 3, wherein
the driving characteristic group includes two or more driving characteristic information items that, respectively, reproduce driving characteristics of manual driving operations performed by two or more different drivers.

5. The vehicle control apparatus according to claim 2, further comprising
a display control unit that displays, on a display device, a difference between the driving characteristic defined as a reference driving characteristic and the driving characteristic corresponding to the driving characteristic information item displayed as a selection candidate when the user selects the driving characteristic information item.

6. The vehicle control apparatus according to claim 1, wherein
the driving characteristic information item includes at least one of an inter-vehicle distance characteristic element, a deceleration characteristic element, an acceleration characteristic element, a lateral distance characteristic element, or a temporary stop characteristic element.

7. The vehicle control apparatus according to claim 1, further comprising
a position acquisition unit that acquires a current area of the vehicle,
wherein
the characteristic setting unit sets the driving characteristic to be used in the autonomous driving with an area characteristic information item and a general characteristic information item, and
the area characteristic information item is acquired corresponding to the current area of the vehicle and the general characteristic information item is acquired regardless of the current area of the vehicle.

8. The vehicle control apparatus according to claim 7, wherein
the area characteristic information item is generated by machine learning based on multiple driving characteristics indicating multiple manual driving operations performed by multiple drivers in a specific area.

9. The vehicle control apparatus according to claim 7, wherein,
when the current area changes, the characteristic setting unit sets the driving characteristic to be used in the autonomous driving with the area characteristic information item corresponding to the current area after change.

10. The vehicle control apparatus according to claim 7, wherein,
when both of the area characteristic information item and the general characteristic information item are able to be set for a same element of the driving characteristic, the characteristic setting unit sets the driving characteristic of the autonomous driving with the area characteristic information item by assigning a higher priority to the area characteristic information item than the general characteristic information item.

11. The vehicle control apparatus according to claim 7, wherein
the area characteristic information item includes a driving characteristic element that is not included in the general characteristic information item.

12. The vehicle control apparatus according to claim 1, further comprising
a time acquisition unit that acquires a current time,
wherein the characteristic setting unit sets the driving characteristic to be used in the autonomous driving with the driving characteristic information item, which corresponds to the current time acquired by the time acquisition unit, among multiple driving characteristic information items different from one another depending on time information.

13. A vehicle control method that controls an execution of an autonomous driving of a vehicle, the vehicle control method comprising:
acquiring a driving characteristic information item indicating a numerical value or a degree of a driving characteristic to be used in an autonomous driving of the vehicle; and
setting the driving characteristic to be used in the autonomous driving of the vehicle with the acquired driving characteristic information item,
wherein the driving characteristic to be used in the autonomous driving is set with the acquired driving characteristic information item to be different from a driving characteristic of a manual driving performed by a user of the vehicle.

14. A vehicle control program product that controls an execution of an autonomous driving of a vehicle, the vehicle control program product being stored in a computer-readable non-transitory tangible storage medium as instructions to be executed by a computer, the instructions comprising:
acquiring a driving characteristic information item indicating a numerical value or a degree of a driving characteristic to be used in an autonomous driving of the vehicle; and
setting the driving characteristic to be used in the autonomous driving of the vehicle with the acquired driving characteristic information item,
wherein the driving characteristic to be used in the autonomous driving is set with the acquired driving characteristic information item to be different from a driving characteristic of a manual driving performed by a user of the vehicle.
